(19) United States
(12) Patent Application Publication
(10) Pub. No.: US 2012/0233394 A1
(43) Pub. Date: Sep. 13, 2012

(54) MEMORY CONTROLLER AND A CONTROLLING METHOD ADAPTABLE TO DRAM

(75) Inventor: Hsingho Liu, Hsinchu City (TW)

(73) Assignee: SKYMEDI CORPORATION, Hsinchu City (TW)

(21) Appl. No.: 13/045,373

(22) Filed: Mar. 10, 2011

(51) Int. Cl. G06F 12/00

(52) U.S. Cl. 711/105; 711/E12.001

(57) ABSTRACT

A memory controller and controlling method adaptable to a dynamic random access memory (DRAM) are disclosed. A DRAM controller is configured to manage flow of data to and from the DRAM. A write buffer is controlled by the DRAM controller to temporarily store an entry of data to be written to the DRAM. The data to be written is stored in the write buffer if the write buffer is empty, and the stored data and a succeeding data to be written are both written to the DRAM.

### BACKGROUND OF THE INVENTION

1. Field of the Invention

The present invention generally relates to a memory controller, and more particularly to a memory controller adaptable to a dynamic random access memory (DRAM).

2. Description of Related Art

Dynamic random access memory (DRAM) is a type of volatile memory that stores each data bit in an individual capacitor. DRAM has a variety of forms such as synchronous DRAM (SDRAM), double data rate (DDR) SDRAM, DDR2 SDRAM, and DDR3 SDRAM, which have different densities or operating speeds respectively.

A memory controller, such as a DRAM controller, is a circuit that manages the flow of data to and from a memory such as DRAM. The memory controller controls reading and writing by selecting row and column data addresses of the memory.

In addition to the memory controller, a modern memory is equipped with a cache scheme that stores data in a cache memory such as static random access memory (SRAM). When a requested data is held in the cache memory (i.e., cache hit), the data may be fast read from the cache memory, thereby improving memory access performance. Otherwise (i.e., cache miss), the requested data should be slowly fetched from the memory. Various write policies are provided for the cache to write data into the cache memory.

Conventional cache scheme uses a cache memory of a large size, for example, fitted to store hundreds or thousands of entries of data. The conventional cache scheme uses a complicated cache control circuit and algorithm to carry out the cache hit/miss determination. Accordingly, a substantive circuit area is required to accommodate the cache memory and the cache control circuit, thereby increasing chip area.

For the foregoing reasons, a need has arisen to propose a novel memory controller adaptable to a memory such as DRAM to reduce chip area without substantively compromising memory access performance.

### SUMMARY OF THE INVENTION

In view of the foregoing, it is an object of the embodiment of the present invention to provide a memory controller adaptable to a dynamic random access memory (DRAM) with small-size buffer and uncomplicated algorithm.

According to one embodiment, a memory controller adaptable to a dynamic random access memory (DRAM) includes a DRAM controller and a write buffer. The DRAM controller is configured to manage flow of data to and from the DRAM. The write buffer is controlled by the DRAM controller to temporarily store an entry of data to be written to the DRAM. The data to be written is stored in the write buffer if the write buffer is empty, and the stored data and a succeeding data to be written are both written to the DRAM.

### BRIEF DESCRIPTION OF THE DRAWINGS

FIG. 1 shows a block diagram of a memory controller adaptable to a dynamic random access memory (DRAM) according to one embodiment of the present invention;

FIG. 2 shows a flow diagram illustrative of data access flow of the DRAM according to one embodiment of the present invention;

FIG. 3A shows a timing diagram illustrative of writing two entries of data without a write buffer;

FIG. 3B shows a timing diagram illustrative of writing two entries of data with the write buffer according to the embodiment of the present invention;

FIG. 4 shows timing diagrams illustrative of writing three entries of data without a write buffer; and

FIG. 5 shows timing diagrams illustrative of writing three entries of data with the write buffer according to the embodiment of the present invention.

### DETAILED DESCRIPTION OF THE INVENTION

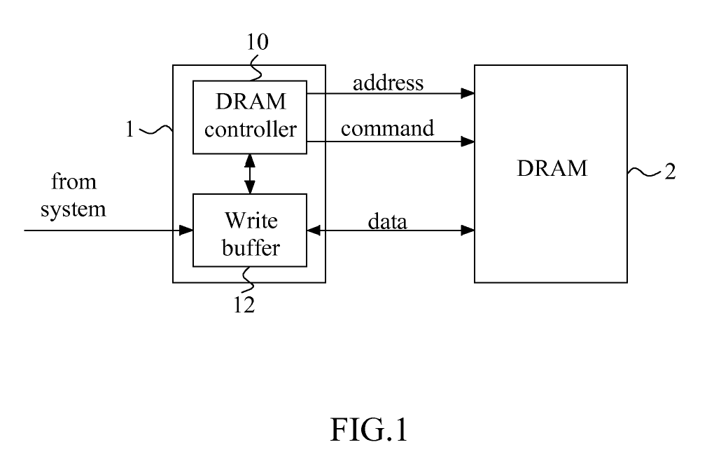

FIG. 1 shows a block diagram of a memory controller 1 adaptable to a dynamic random access memory (DRAM) 2 according to one embodiment of the present invention. The DRAM 2 may be, but is not limited to, synchronous DRAM (SDRAM), double data rate (DDR) SDRAM, DDR2 SDRAM, or DDR3 SDRAM.

In the embodiment, the memory controller 1 includes a DRAM controller 10 configured to manage the flow of data to and from the DRAM 2. According to one aspect of the present embodiment, the memory controller 1 includes a write buffer 12 for temporarily storing data to be written to the DRAM 2, but includes no read buffer. The write buffer 12 of the embodiment has a small size, and preferably has a size fitted to store a single entry of data addressable by an individual address.

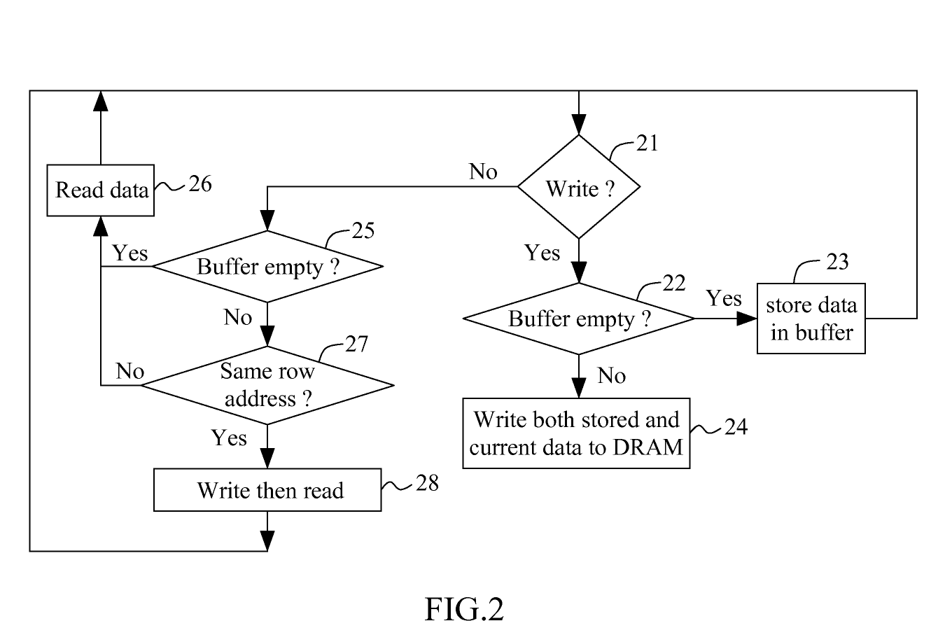

FIG. 2 shows a flow diagram illustrative of data access flow of the DRAM 2 according to one embodiment of the present invention. Specifically, in step 21, the DRAM controller 10 determines whether a write command is received. If it is determined that the write command is received, the DRAM controller 10 further determines, in step 22, whether the write buffer 12 is empty. If it is determined that the write buffer 12 is empty, the data received, for example, from an electronic system such as a system on chip (SOC) is then stored in the write buffer 12 (step 23). Otherwise, if the write buffer is not empty (i.e., an entry of preceding data has been stored in the write buffer 12 but has not yet been retrieved), the preceding data stored in the write buffer 12 and the current data received from the system are both written to DRAM 2 (step 24).

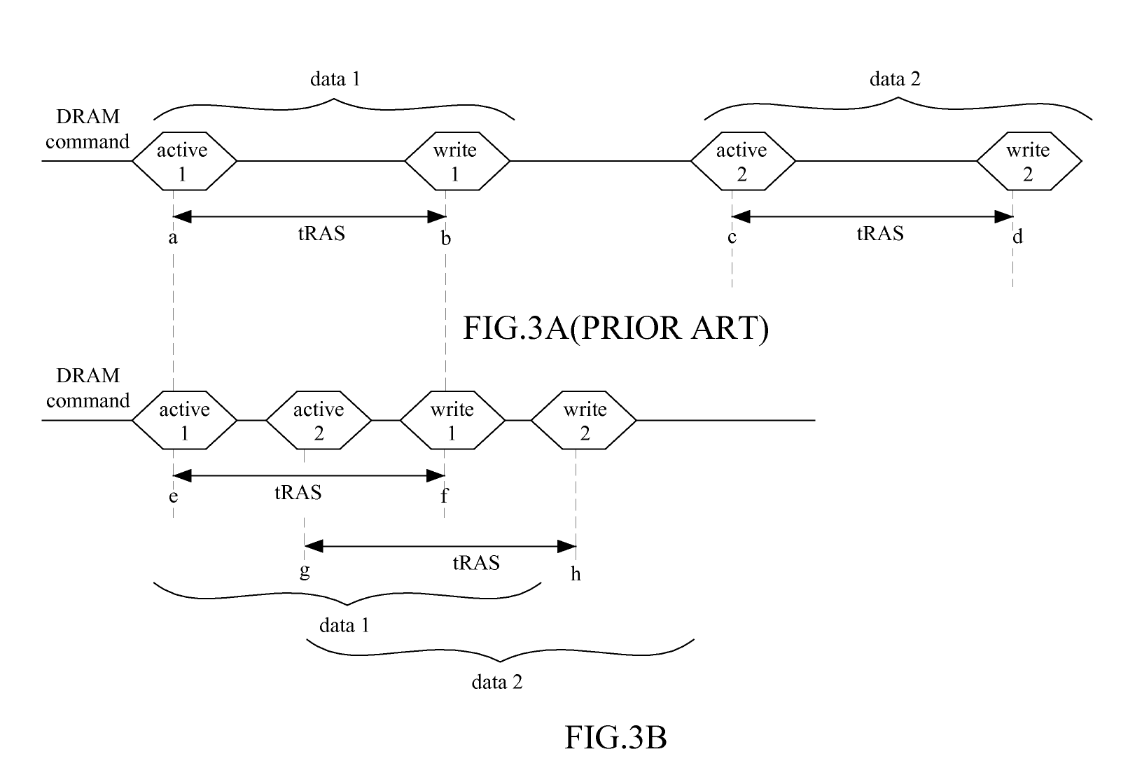

FIG. 3A shows a timing diagram illustrative of writing two entries of data (e.g., data 1 and data 2) without a write buffer, and FIG. 3B shows a timing diagram illustrative of writing two entries of data with the write buffer according to the embodiment of the present invention. In the timing diagrams, “active #” (# is 1 or 2) indicates a row access time during which a row address is issued from the DRAM controller 10 to the DRAM 2, and “write #” (# is 1 or 2) indicates a write command time during which a write command is issued from the DRAM controller 10 to the DRAM 2. It is noted that a row active time tRAS is needed between the row access time active # and the write command time write # (e.g., time a to b in FIG. 3A).

Regarding FIG. 3A, data 2 is written after data 1 has been completely written. Regarding FIG. 3B, as data 1 and data 2 are both available owing to the write buffer 12, the row access time active 2 of data 2 may proceed after the row issue time active 1 but before the write command time write 1 of data 1. As a result, the row active time of data 1 (e.g., time e to f) is partially overlapped with the row active time of data 2 (e.g., time g to h). Accordingly, the time needed to write data 1 and 2 (e.g., time e to h) according to the embodiment is substantially shorter than the time needed to write data 1 and 2 (e.g., time a to d) without a write buffer.

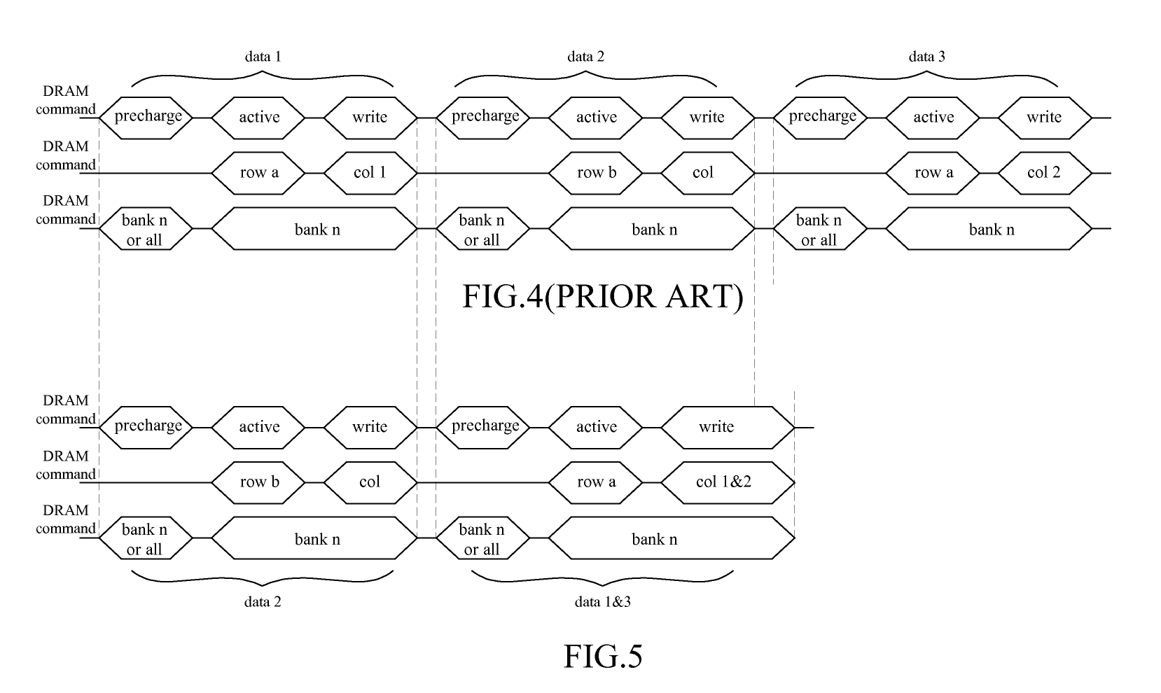

FIG. 4 shows timing diagrams illustrative of writing three entries of data (e.g., data 1, data 2 and data 3) without a write buffer, and FIG. 5 shows timing diagrams illustrative of writing three entries of data with the write buffer 12 according to the embodiment of the present invention. In this example, data 1 has a row address a (and a column address 1), data 2 has a row address b, and data 3 has the row address a (and a column address 2) with the same row address as the data 1.

Regarding FIG. 4, data 2 is written after data 1 has been completely written, and data 3 is written after data 2 has been completely written. It is noted that, as adjacent data have different row addresses, a precharge time is needed between the write command time and the succeeding row access time (active).

Regarding FIG. 5, as data 1 has been stored in the write buffer 12, data 1 and data 3 having the common row address a may be written to the DRAM 2 after data 2 has been completely written. As a result, compared to FIG. 4, at least one row access time (active) may be saved. Accordingly, memory writing time may be substantially reduced by altering the writing order of the incoming data.

Referring back to FIG. 2, if it is determined in step 21 that a read command is received, the DRAM controller 10 further determines in step 25 whether the write buffer 12 is empty. If the write buffer 12 is empty, the read operation (step 26) is performed. If the write buffer 12 is determined not empty, that is, there is data stored in the write buffer 12, the row addresses of data to be read and data to be written are compared in step 27. If their row addresses are not the same, only the read operation (step 26) is performed by reading data from the DRAM 2 but not writing the stored data to the DRAM 2. As no write operation is performed in this case, a write recovery time (i.e., the time needed after the write operation and before the next read operation may be performed) can be saved.

On the other hand, in step 27, if the row address of data to be read is the same as the row address of data to be written, the write operation is performed, followed, by the read operation (step 28). As the write operation and the read operation have the same row address, one time of the row access time can thus be saved in a manner similar to that shown in FIG. 5.

Although specific embodiments have been illustrated and described, it will be appreciated by those skilled in the art that various modifications may be made without departing from the scope of the present invention, which is intended to be limited solely by the appended claims.

1. A memory controller adaptable to a dynamic random access memory (DRAM), comprising:
a DRAM controller configured to manage flow of data to and from the DRAM; and
a write buffer controlled by the DRAM controller to temporarily store an entry of data to be written to the DRAM;
wherein the data to be written is stored in the write buffer if the write buffer is empty, and the stored data and a succeeding data to be written are both written to the DRAM.

2. The memory controller of claim 1, wherein the DRAM is synchronous DRAM (SDRAM), double data rate (DDR) SDRAM, DDR2 SDRAM or DDR3 SDRAM.

3. The memory controller of claim 1, wherein the write buffer has a size fitted to store a single entry of data addressable by an individual address.

4. The memory controller of claim 1, wherein the memory controller comprises no read buffer configured to store data to be read from the DRAM.

5. The memory controller of claim 1, wherein the succeeding data is next to the stored data, and wherein the stored data and the succeeding data are both written to the DRAM in a manner that a row active time of writing the stored data is partially overlapped with the row active time of writing the succeeding data.

6. The memory controller of claim 1, wherein the succeeding data comes after the stored data; the succeeding data and the stored data have a common row address; and a written data received between the stored data and the succeeding data is written to the DRAM before the stored data and the succeeding data are written to the DRAM.

7. The memory controller of claim 1, wherein a read operation is performed without performing a write operation when the write buffer is not empty, and a row address of the data to be read is different from the row address of the stored data.

8. The memory controller of claim 1, wherein a write operation is performed, followed by performing a read operation when the write buffer is not empty, and the data to be read and the stored data have same row addresses.

9. A memory controlling method adaptable to a dynamic random access memory (DRAM), comprising:
managing flow of data to and from the DRAM by a DRAM controller;
providing a write buffer to temporarily store an entry of data to be written to the DRAM;
storing the data to be written in the write buffer if the write buffer is empty; and
writing both the stored data and a succeeding data to be written to the DRAM.

10. The memory controlling method of claim 9, wherein the DRAM is synchronous DRAM (SDRAM), double data rate (DDR) SDRAM, DDR2 SDRAM or DDR3 SDRAM.

11. The memory controlling method of claim 9, wherein the write buffer has a size fitted to store a single entry of data addressable by an individual address.

12. The memory controlling method of claim 9, wherein no read buffer is controlled, by the DRAM controller to store data to be read from the DRAM.

13. The memory controlling method of claim 9, wherein the succeeding data is next to the stored data, and wherein the stored data and the succeeding data are both written to the DRAM in a manner that a row active time of writing the stored data is partially overlapped with the row active time of writing the succeeding data.

14. The memory controlling method of claim 9, wherein the succeeding data comes after the stored data; the succeeding data and the stored data have a common row address; and a written data received between the stored data and the succeeding data is written to the DRAM before the stored data and the succeeding data are written to the DRAM.

15. The memory controlling method of claim 9, further comprising performing a read operation but not performing a write operation when the write buffer is not empty, and a row address of the data to be read is different from the row address of the stored data.

16. The memory controlling method of claim 9, further comprising performing a write operation, followed by performing a read operation when the write buffer is not empty, and the data to be read and the stored data have same row addresses.
